(19) United States
(12) Patent Application Publication
(10) Pub. No.: US 2009/0287638 A1
(43) Pub. Date: Nov. 19, 2009

(54) AUTONOMIC SYSTEM-WIDE SQL QUERY PERFORMANCE ADVISOR

(76) Inventors: Robert Joseph Bestgen, Rochester, MN (US); Michael W. Cain, Rochester, MN (US); Shantan Kethireddy, Rolling Meadows, IL (US)

Correspondence Address: IBM CORPORATION, 3605 HIGHWAY 52 NORTH, DEPT. 917, BUILDING 006-1, ROCHESTER, MN, 55901-7829, US

(21) Appl. No.: 12/120,752

(22) Filed: May 15, 2008

(51) Int. Cl. G06F 17/30

(52) U.S. Cl. 707/2; 707/E17.017

(57) ABSTRACT

A method, computer program product and computer system for providing SQL query performance advices to optimize SQL queries of a database, which includes providing a query cache to store records of optimized queries of the database, creating an event-driven web service, sending the records from the query cache to the web service, and analyzing the records using the web service to form SQL query performance advices. The method, computer program product and computer system can further includes outputting the SQL query performance advices to a viewer for display, or outputting the advices to a post-processing application for additional actions.

### BACKGROUND

1. Technical Field

The present invention relates to SQL queries of a database. More specifically, it relates to an autonomic SQL query performance advisory method to optimize SQL queries input to a database.

2. Background Information

A computer system typically operates according to the instructions of computer programs. A computer program that supports the access to information in a database is called a database management system (DBMS), which helps other computer programs access, manipulate, and save information in a database.

A DBMS has means to access and manage a database to aid users, developers, or other programs in accessing information in the database. One such means is the structured query language (SQL), which is used to request information from a database. Although there is an ANSI (American National Standards Institute) standard for SQL, many versions of SQL exist that include different extensions. For instance, one example of a database query expressed in SQL is as follows:

select * from stores, transactions

where stores.location=“Minnesota”

and stores.storeID=transactions.storeId

In this example, the SQL query accesses information in a database by selecting records from two tables (“stores” and “transactions”) of the database. The selected records are those who have a value “Minnesota” in their “store location” field and have a “store ID” that matches a “store ID” in “transactions”. To execute this query, an SQL engine will first retrieve records from the stores table and then retrieve records from the transaction table. Records that satisfy the query requirements are then merged to create the final output.

In many systems, to execute an SQL query, the query is first parsed, a logical plan of this query is generated, and then at least one, often multiple physical plans are created for executing the logical plan. The multiple physical plans can achieve the same correct output, but may take greatly varying times to arrive at that output, depending on which plan is selected by the system for execution. The best plan is usually the one having the lowest expected cost, typically selected by a query optimizer. A query optimizer selects the best plan according to the statistics over the underlying tables and columns. This is called the cost based model and is the de-facto standard for databases.

The SQL Query Engine (SQE) is one such query optimization technique. The SQE uses an SQE Plan Cache to store optimized queries. The SQE Plan Cache is a repository that contains access plans for queries that were optimized by the SQE. The purpose of the SQE Plan Cache is to facilitate the reuse of a query access plan when the same query is re-executed, and to store runtime information for subsequent use in future query optimizations.

Plans in the SQE Plan Cache are volatile and they persist until an Initial Program Load (IPL) occurs. The plans contain a large amount of valuable optimization data that can be used by a user to improve query performance, and, if provided at IPL, to avoid the warm-up effect that the system suffers to improve its optimization performance. The plans are collected without user intervention or any monitoring overhead, which makes the SQE Plan Cache invaluable for tuning SQL queries. The SQE Plan Cache, and the associated plan cache mining and performance tuning methods, greatly improve the database query performance.

However, the SQE Plan Cache and the associated plan cache mining and performance tuning methods cannot be easily modified or updated. For example, in order to add new performance tuning features to the performance tuning method associated with the SQE Plan cache, a user must download all required Database Program Temporary Fixes (PTFs) that contain solutions to fix known bugs for the database product, as well as the latest version of the graphical user interface (GUI) for managing and administering the database servers, e.g. the IBM iSeries Navigator. Moreover, making changes or additions to previous versions of the SQE Plan Cache and the associated plan cache mining and performance tuning methods is both time-consuming and costly.

### SUMMARY

A method, computer program product and computer system for providing SQL query performance advices to optimize SQL queries of a database, which includes providing a query cache to store records of optimized queries of the database, creating an event-driven web service, sending the records from the query cache to the web service, and analyzing the records using the web service to form SQL query performance advices. The method, computer program product and computer system can further includes outputting the SQL query performance advices to a viewer for display, or outputting the advices to a post-processing application for additional actions

### BRIEF DESCRIPTION OF DRAWINGS

FIG. 1 is a block diagram of an autonomic SQL query performance advisory method.

FIG. 2 is a flowchart illustrating the process of creating an autonomic SQL query performance advisory method.

FIG. 3 is a conceptual diagram of a computer system in which the present invention can be utilized.

### DETAILED DESCRIPTION

The invention will now be described in more detail by way of example with reference to the embodiments shown in the accompanying Figures. It should be kept in mind that the following described embodiments are only presented by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only on a relative basis.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention relates to an autonomic system-wide SQL query performance advisory method, which can be easily modified or updated when fixes or enhancements of the method are available.

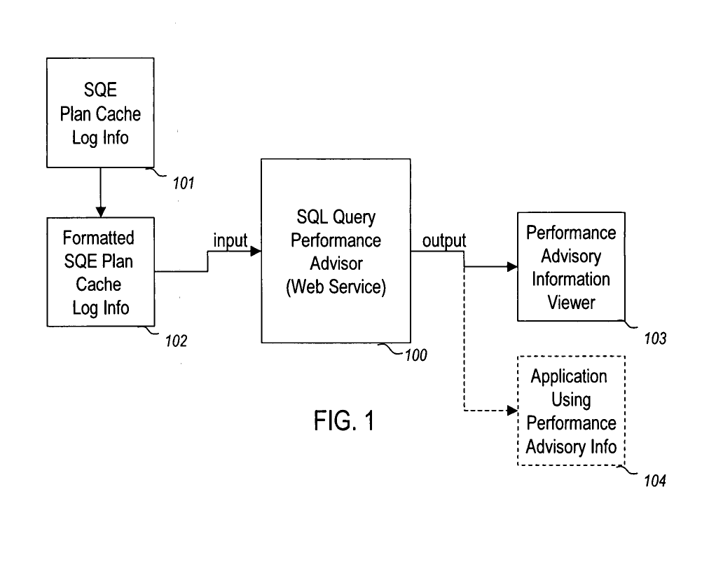

The SQL query performance advisory method is described with reference to FIG. 1. In one embodiment of the present invention, a flexible, event driven web service 100 is created to manage the SQL query performance. The web service takes a log 101 in a query information repository, e.g. the SQE Plan Cache, as the input. This log information is converted to a flattened XML file 102, in which no nested nodes are allowed. In an alternate embodiment of the present invention, the input can be the log information in other formats, such as the Database Monitor format, to help support previous releases of the SQE and related software. The output of the web service is a report defining all SQL performance advisory data generated from mining the plan cache, which can be viewed by a performance advisory information viewer 103. The advisory information from the web service 100 contains tuning recommendations based on the database engine producing the input stream. For example, a web service may advise an encoded vector index (EVI) for an IBM system 15 DB2, but would not for an IBM z/OS DB2. In one embodiment of the present invention, the SQL performance advisory information contains one or more of index advisor information, materialized query tables (MQTs) advisor information, temporary index information, open data path reuse information, table reorganization information, and other information that can be used to improve query performance. In addition, the web service can be implemented using a single piece of source code, which enables an easy update of the web service, when fixes or enhancements are available. This relieves a user from having to apply multiple server fixes and load client application code in order to update or modify the performance advisory method. Users obtain the advisory information in the returned stream format, through a viewer. Alternatively, extensible applications 104 can be installed to utilize the feedback provided by the performance advisory service. For example, a user application can do “self-tuning” by requesting index advice for the top n queries, and then create these indexes. This is especially appealing for the applications where the SQL is built on the fly, and proactive tuning is problematic.

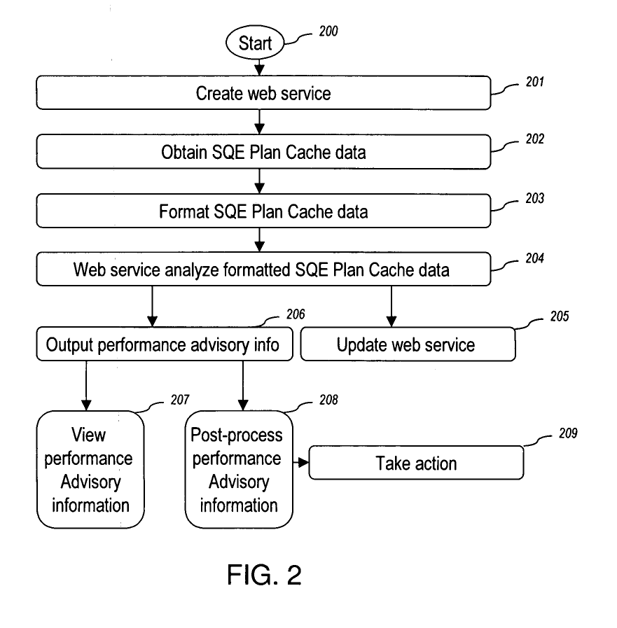

FIG. 2 is a flowchart illustrating the process of creating an autonomic SQL query performance advisory method. In one embodiment of the present invention, the process starts at state 200. In state 201, a web service is created, and corresponding WSDL (Web Services Description Language) definitions are created. The WSDL is a document written in XML format for describing a web service. It specifies the location of the service and the operations (or methods) the service exposes. The WSDL document defines services as collections of network endpoints, or ports, where a port is a network address associated with a reusable binding, and a collection of ports define a service. Messages are abstract descriptions of the data being exchanged. The concrete protocol and data format specifications for a particular port type constitute a reusable binding, where the messages and operations are then bound to a concrete network protocol and message format. In this way, WSDL describes the public interface to the web service.

In state 202, the web service 100 retrieves SQE Plan Cache log information. In state 203, the retrieved SQE Plan Cache log information 101 is formatted and sent as the input. In one embodiment of the invention, the SQE Plan Cache log information is formatted to a flattened XML stream 102. In an alternate embodiment, the SQE Plan Cache log information is formatted to another format, such as in Database Monitor form, to be compatible to previous releases. Other input formats can also be contemplated by a person with skill in the art. The web service 100 can take as input any group of SQL queries that it can analyze to create any rule-based advice such as index advices. For example, in one embodiment of the present invention, log information can be used to record plan cache change events, which are then flattened into the XML form, and sent to the web service 100 using the Enterprise Service Bus (ESB). This method helps to avoid a long wait time when processing one large plan cache in a single step. However, this method would not allow the service to generate information that requires looking at the plan cache in aggregate (or a larger portion) rather than single pieces. For example, to generate an effective MQT advice, a large number of SQE Plan Cache entries, instead of individual entries, need to be analyzed.

Next in state 204, the web service 100 analyzes the records in the XML stream or other formats to come up with performance advice. For instance, the web service 100 analyzes the group of entries that are most commonly run, along with those with the longest running time, to generate MQT definitions that can be used to improve query performance. It can also analyze the query entries to determine index advised information, reusable Open Database Path (ODP) advice, online reorganization information, etc. In state 205 when there is any performance tuning update or modification, only the web service 100 needs to be updated or modified.

In state 206, the web service 100 outputs a stream in the XML form. In an alternate embodiment of the present invention, the stream can be in a different format that can be viewed by a user via a GUI application, or which can be processed by a post-processing application. Then in state 207, a user can view and analyze the output SQL query performance advices using the performance advisory information viewer 103. An appropriate viewer can be chosen here to parse the XML streams or output files in other formats. The output performance advice is generic, so that the viewer does not need to be updated to understand new pieces of advice, or it would contain a common area for new features. Alternatively in state 208, the SQL query performance advices output is sent to an application, which is used to post-process the advices to take necessary action in state 209, for example, perform an optimization.

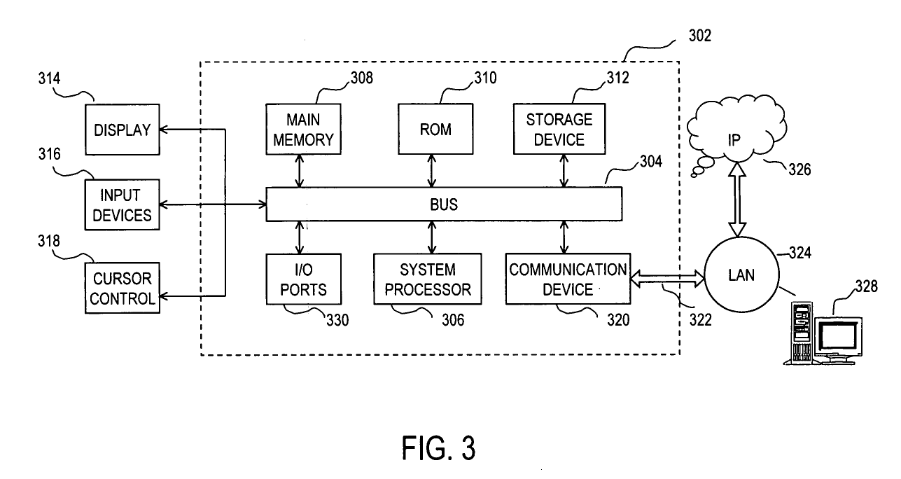

FIG. 3 illustrates a computer system (302) upon which the present invention may be implemented. The computer system may be any one of a personal computer system, a work station computer system, a lap top computer system, an embedded controller system, a microprocessor-based system, a digital signal processor-based system, a hand held device system, a personal digital assistant (PDA) system, a wireless system, a wireless networking system, etc. The computer system includes a bus (304) or other communication mechanism for communicating information and a processor (306) coupled with bus (304) for processing the information. The computer system also includes a main memory, such as a random access memory (RAM) or other dynamic storage device (e.g., dynamic RAM (DRAM), static RAM (SRAM), synchronous DRAM (SDRAM), flash RAM), coupled to bus for storing information and instructions to be executed by processor (306). In addition, main memory (308) may be used for storing temporary variables or other intermediate information during execution of instructions to be executed by processor. The computer system further includes a read only memory (ROM) 310 or other static storage device (e.g., programmable ROM (PROM), erasable PROM (EPROM), and electrically erasable PROM (EEPROM)) coupled to bus 304 for storing static information and instructions for processor. A storage device (312), such as a magnetic disk or optical disk, is provided and coupled to bus for storing information and instructions. This storage device is an example of a computer readable medium.

The computer system also includes input/output ports (330) to input signals to couple the computer system. Such coupling may include direct electrical connections, wireless connections, networked connections, etc., for implementing automatic control functions, remote control functions, etc. Suitable interface cards may be installed to provide the necessary functions and signal levels.

The computer system may also include special purpose logic devices (e.g., application specific integrated circuits (ASICs)) or configurable logic devices (e.g., generic array of logic (GAL) or re-programmable field programmable gate arrays (FPGAs)), which may be employed to replace the functions of any part or all of the method as described with reference to FIG. 1-2. Other removable media devices (e.g., a compact disc, a tape, and a removable magneto-optical media) or fixed, high-density media drives, may be added to the computer system using an appropriate device bus (e.g., a small computer system interface (SCSI) bus, an enhanced integrated device electronics (IDE) bus, or an ultra-direct memory access (DMA) bus). The computer system may additionally include a compact disc reader, a compact disc reader-writer unit, or a compact disc jukebox, each of which may be connected to the same device bus or another device bus.

The computer system may be coupled via bus to a display (314), such as a cathode ray tube (CRT), liquid crystal display (LCD), voice synthesis hardware and/or software, etc., for displaying and/or providing information to a computer user. The display may be controlled by a display or graphics card. The computer system includes input devices, such as a keyboard (316) and a cursor control (318), for communicating information and command selections to processor (306). Such command selections can be implemented via voice recognition hardware and/or software functioning as the input devices (316). The cursor control (318), for example, is a mouse, a trackball, cursor direction keys, touch screen display, optical character recognition hardware and/or software, etc., for communicating direction information and command selections to processor (306) and for controlling cursor movement on the display (314). In addition, a printer (not shown) may provide printed listings of the data structures, information, etc., or any other data stored and/or generated by the computer system.

The computer system performs a portion or all of the processing steps of the invention in response to processor executing one or more sequences of one or more instructions contained in a memory, such as the main memory. Such instructions may be read into the main memory from another computer readable medium, such as storage device. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The computer system also includes a communication interface coupled to bus. The communication interface (320) provides a two-way data communication coupling to a network link (322) that may be connected to, for example, a local network (324). For example, the communication interface (320) may be a network interface card to attach to any packet switched local area network (LAN). As another example, the communication interface (320) may be an asymmetrical digital subscriber line (ADSL) card, an integrated services digital network (ISDN) card or a modem to provide a data communication connection to a corresponding type of telephone line. Wireless links may also be implemented via the communication interface (320). In any such implementation, the communication interface (320) sends and receives electrical, electromagnetic or optical signals that carry digital data streams representing various types of information.

Network link (322) typically provides data communication through one or more networks to other data devices. For example, the network link may provide a connection to a computer (326) through local network (324) (e.g., a LAN) or through equipment operated by a service provider, which provides communication services through a communications network (328). In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit notifications and receive data, including program code, through the network(s), the network link and the communication interface.

It should be understood, that the invention is not necessarily limited to the specific process, arrangement, materials and components shown and described above, but may be susceptible to numerous variations within the scope of the invention.

What is claimed is:

1. A method for providing SQL query performance advices to optimize an SQL query of a database, comprising:
providing a query information repository to store records of optimized queries of the database;
creating an event-driven web service;
sending the records from the query information repository to the web service; and
analyzing the records using the web service to form the SQL query performance advices.

2. The method of claim 1, further comprising outputting the SQL query performance advices to a viewer for display.

3. The method of claim 1, further comprising outputting the SQL query performance advices to a post-processing application.

4. The method of claim 1, further comprising, before sending the records to the web service, obtaining the records from the query information repository and formatting the records.

5. The method of claim 4, wherein the formatting comprises converting the records into a stream of a standard format.

6. The method of claim 5, wherein the standard format is an XML format.

7. The method of claim 1, wherein the SQL query performance advices comprise tuning recommendations based on a database engine that generates the optimized queries.

8. The method of claim 1, wherein the query information repository is an SQE Plan Cache.

9. A computer program product for providing SQL query performance advices to optimize an SQL query of a database, the computer program product comprising:
a computer usable medium having computer usable program code embodied therewith, the computer usable program code comprising:
instructions to provide a query information repository to store records of optimized queries of the database;
instructions to create an event-driven web service;
instructions to send the records from the query information repository to the web service; and
instructions to analyze the records using the web service to form the SQL query performance advices.

10. The computer program product of claim 9, further comprising instructions to output the SQL query performance advices to a viewer for display.

11. The computer program product of claim 9, further comprising instructions to output the SQL query performance advices to a post-processing application.

12. The computer program product of claim 9, further comprising instructions, before sending the records to the web service, to obtain the records from the query information repository and to format the records.

13. The computer program product of claim 12, wherein the instructions to format comprise instructions to convert the records into a stream of a standard format.

14. The computer program product of claim 13, wherein the standard format is an XML format.

15. The computer program product of claim 9, wherein the SQL query performance advices comprise tuning recommendations based on a database engine that generates the optimized queries.

16. The computer program product of claim 9, wherein the query information repository is an SQE Plan Cache.

17. A computer system comprising:
a processor;
a memory operatively coupled with the processor;
a storage device operatively coupled with the processor and the memory; and
a computer program product for providing SQL query performance advices to optimize an SQL query of a database, the computer program product comprising:
a computer usable medium having computer usable program code embodied therewith, the computer usable program code comprising:
instructions to provide a query information repository to store records of optimized queries of the database;
instructions to create an event-driven web service;
instructions to send the records from the query information repository to the web service; and
instructions to analyze the records using the web service to form the SQL query performance advices.

18. The computer system of claim 17, further comprising instructions to output the SQL query performance advices to a viewer for display.

19. The computer system of claim 17, further comprising instructions to output the SQL query performance advices to a post-processing application.

20. The computer system of claim 17, further comprising instructions, before sending the records to the web service, to obtain the records from the query information repository and to format the records.

21. The computer system of claim 20, wherein the instructions to format comprise instructions to convert the records into a stream of a standard format.

22. The computer system of claim 21, wherein the standard format is an XML format.

23. The computer system of claim 17, wherein the SQL query performance advices comprise tuning recommendations based on a database engine that generates the optimized queries.

24. The computer system of claim 17, wherein the query information repository is an SQE Plan Cache.
